(19) United States
(12) Patent Application Publication
(10) Pub. No.: US 2004/0094054 A1
(43) Pub. Date: May 20, 2004

(54) Plate cylinder with splined shell

(75) Inventors: Kenneth Waldo Brown, Barrington, NH (US); Jared Paul Eaton, Stratham, NH (US); Lev Zlatin, Portsmouth, NH (US)

Correspondence Address: DAVIDSON, DAVIDSON & KAPPEL, LLC, 485 SEVENTH AVENUE, 14TH FLOOR, NEW YORK, NY, 10018, US

(73) Assignee: Heidelberger Druckmaschinen AG, Heidelberg (DE)

(21) Appl. No.: 10/300,447

(22) Filed: Nov. 20, 2002

(51) Int. Cl. B41F 27/00

(52) U.S. Cl. 101/382.1

(57) ABSTRACT

A plate cylinder has a cylinder body having a cylinder body outer surface for a first image to be printed and a first end, and a shell having an inner surface circumferentially disposed about the first end and having a gap for holding a printing plate, the shell being axially and circumferentially moveable with respect to the first end and having a shell outer surface for a second image to be printed, the inner surface having at least one projection directed inwardly, the gap extending into the projection.

### BACKGROUND INFORMATION

The present invention relates generally to printing presses and more particularly to plate cylinders for printing presses.

Japanese Patent Application No. 2000-954 A shows a printing plate cylinder with a cylinder body and a shell mounted to a reduced diameter portion of the cylinder body for independent movement of the shell in order to adjust the lateral and circumferential register of a printing plate mounted to the shell with respect to the printing plate mounted on the cylinder body on the other side of the printing plate cylinder. The shell has a uniform thickness.

### BRIEF SUMMARY OF THE INVENTION

Commonly-owned European Patent Application No. 1 913 059 discloses a plate cylinder in which shells are movable with respect to a cylinder body using axially-extending arms gripping the underside of the shells, and corresponds to U.S. patent application Ser. No. 09/675,494, which is hereby incorporated by reference herein.

Commonly-owned German Patent Application No. 101 35 506 discloses a plate cylinder in which a shell is axially movable but circumferentially fixed with respect to a cylinder body, and corresponds to U.S. patent application Ser. No. 09/627,639, which is hereby incorporated by reference herein.

An object of the present invention is to provide a shell with space for a plate clamping device while minimizing loss of stiffness of the cylinder body. Another alternate or additional object of the present invention is to provide a splined shell connection with a cylinder body in which circumferential register is permissible.

The present invention thus provides a plate cylinder comprising a cylinder body having a cylinder body outer surface for a first image to be printed and a first end, and a shell having an inner surface circumferentially disposed about the first end and having a gap for holding a printing plate, the shell being axially moveable with respect to the first end and having a shell outer surface for a second image to be printed, the inner surface having at least one projection directed inwardly, the gap extending into the projection.

Since gaps for holding printing plates often require a substantial lock-up mechanism, the present invention permits sufficient space for the gap in the projection, while advantageously still permitting a thin shell thickness in other locations.

Preferably, the shell is at least partially circumferentially movable with respect to the cylinder body.

The at least one projection may include a plurality of projections. If more than one printing plate is supported by the shell, a gap may be located in each projection. Preferably, the projections are spaced symmetrically in the circumferential direction.

The cylinder body preferably has at least one outwardly projecting protrusion, and most preferably more than one of such protrusions. Preferably, the projection of the shell fits between two protrusions of the cylinder body. The protrusions may define a space into which the projection fits, the space preferably being wider than the projection, so that the shell is circumferentially movable with respect to the cylinder body.

The cylinder body may have a second end, with a second shell supported on the second end in a similar manner to the first shell.

A lock-up device is preferably located in the gap.

The present invention also provides a plate cylinder comprising a cylinder body having cylinder body outer surface for a first image to be printed and a first end with at least one outwardly-projecting protrusion having a first side and second side defining a space therebetween, and a shell having an inner surface circumferentially disposed about the first end and having a gap for holding a printing plate, the shell being axially moveable with respect to the first end and having a shell outer surface for a second image to be printed, the inner surface having at least one projection directed inwardly to fit into the space, the space being wider than the projection so as to permit circumferential movement of the shell with respect to the first end.

Preferably, a first and a second protrusion are provided, with the first side on the first protrusion and the second side on the second.

### BRIEF DESCRIPTION OF THE DRAWINGS

Exemplary embodiments of the present invention will be further clarified with respect to the following drawings in which:

FIG. 1 shows a plate cylinder according to the present invention with the cylinder body supporting one image and the shell supporting the other;

FIG. 2 shows a cross-section of the plate cylinder of FIG. 1;

FIGS. 3, 4 and 5 show alternate shell and cylinder body end configurations;

FIG. 6 shows a three-image plate cylinder with two shells; and

FIG. 7 shows an exemplary offset lithographic printing press of the present invention.

### DETAILED DESCRIPTION

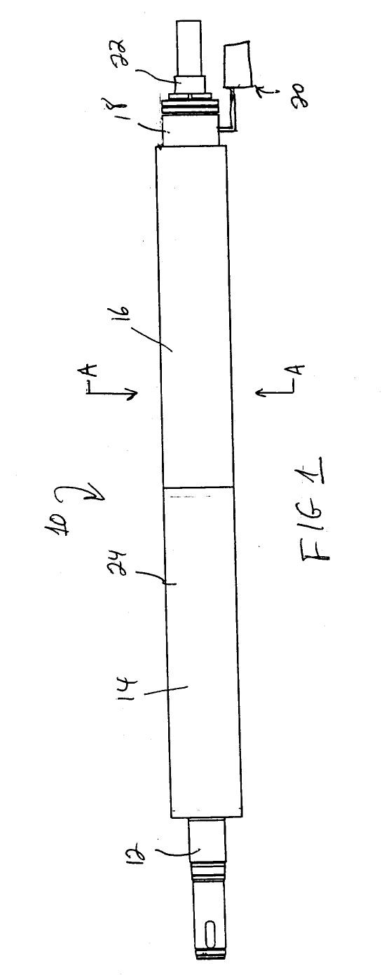

FIG. 1 shows a plate cylinder 10 having a cylinder body 14 with ends 12 and 22. A shell 16 is placed about the cylinder body 14 at the side toward end 22. Cylinder body 14 has an image area 24 on an outer surface, as does shell 16. The image areas have a similar circumference. Shell 16 may be both axially and, to a limited extend, circumferentially registered with respect to a cylinder body outer surface or image area 24, for example through a registration device 20 which contacts a reduced circumference area 18 of shell 16.

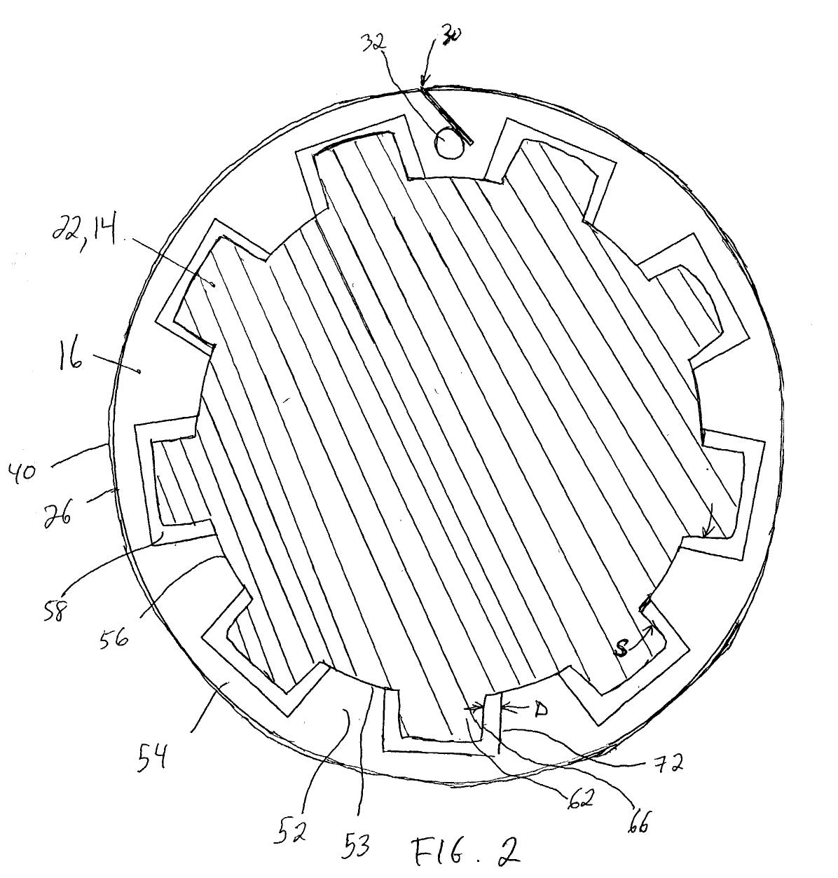

FIG. 2 shows a cross section of the plate cylinder 10 through location A-A of FIG. 1. Shell 16 is disposed circumferentially about end 22 of cylinder body 14. The shell 16 has an inner surface 56 disposed about end 22. End 22 has outwardly-projecting protrusions 62 defining a space S between the protrusions 62.

Inner surface 56 of shell 16 has inwardly-projecting projections 52 to fit into spaces S, the projections defining voids 58. Space S is wider than projection 52 so that a distance D may result between a side 66 of the protrusion 62 a side 72 of the projection 52 and permit circumferential movement of the shell 16 with respect to end 22.

Contact between inner surface 56 and end 22 occurs at contact area 53, which may be provided with a friction-reducing substance, such as PTFE, to aid in axial and circumferential relative motion.

An axially-extending gap 30 is located on an outer surface 26 of shell 16, for holding an image-carrying plate 40, for example a lithographic printing plate. A lock-up device 32 can fasten the plate to the shell 16. Image area 24 of cylinder 14 (FIG. 1) also has an axially-extending gap and a lock-up device for another plate that is spaced axially with respect to plate 40.

The shell 16 thus has reduced thickness areas 54 between projections 52, to accommodate protrusions 62, providing a splined nature of the cylinder body. The splined nature of the shell 16 and body 62 also increases stiffness, which can aid in reducing streaking.

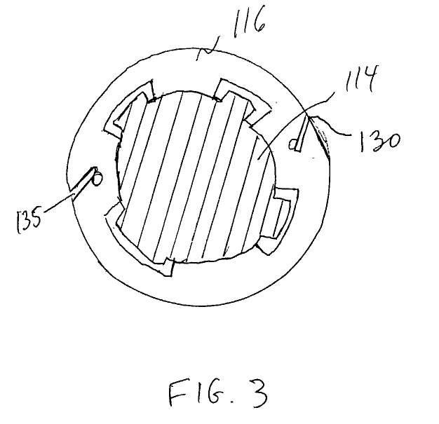

FIG. 3 shows an alternate embodiment of the present invention in which splined shell 116 has four projections, and cylinder body 114 has four protrusions. Two axially extending gaps 130, 135 for printing plates may be provided, so as to define a two-around plate cylinder.

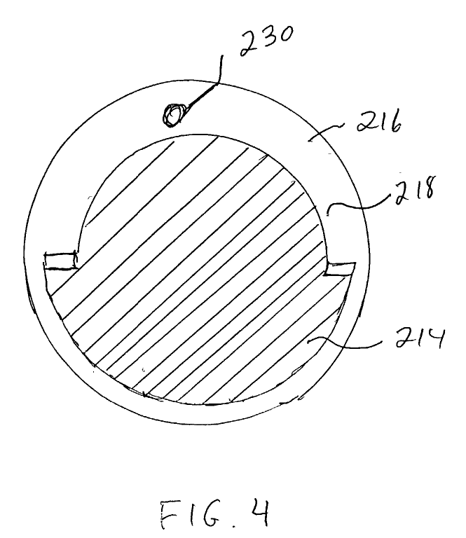

FIG. 4 shows another alternate embodiment with cylinder body 214 having a single protrusion and shell 216 having a single projection 218. A gap 230 may be provided extending into projection 218.

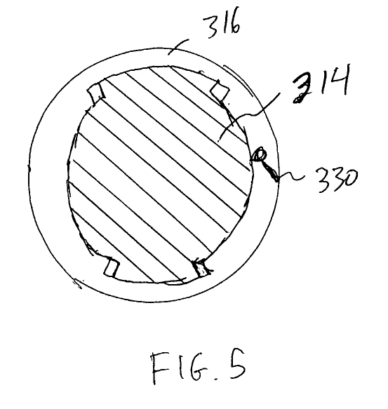

FIG. 5 shows yet another alternate embodiment in which the shell 316 includes a gap 330 in one of two projections, which interleave with two protrusions of cylinder body 314.

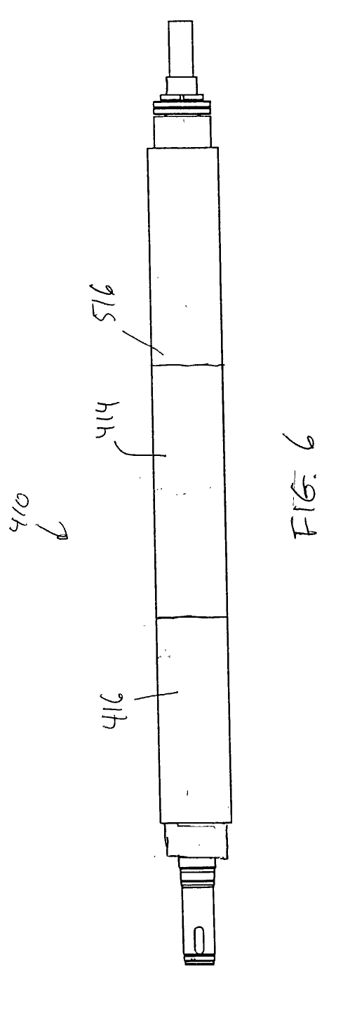

In FIG. 6, two splined shells 416, 516 sandwich a center image area 414 of a cylinder 410, so that three or more axially-spaced image areas may be provided.

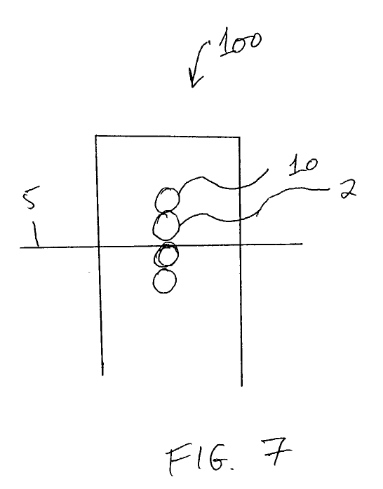

FIG. 7 shows the use of the plate cylinder 10 in an exemplary offset lithographic printing press 100 having a blanket cylinder 2 and a web 5. Once the plates are fastened to plate cylinder 10, the shell 16 and cylinder body 14 can be rotated together during a print run and register can be adjusted axially or circumferentially.

List of Numbers

2 Blanket cylinder

5 Web

10 Plate cylinder

12 End

14 Cylinder body

16 Shell

18 Reduced circumference area

20 Registration device

22 End

26 Surface

30 Gap

32 Lock-up device

40 Plate

52 Projection

53 Contact area

54 Reduced thickness area

56 Inner surface

58 Voids

62 Protrusion

66 Side

72 Side

100 Printing press

114 Body

116 Shell

130 Gap

135 Gap

214 Body

216 Shell

218 Projection

230 Gap

314 Body

316 Shell

330 Gap

410 Cylinder

414 Body

416 Shell

516 Shells

What is claimed is:

1. A plate cylinder comprising:
a cylinder body having a cylinder body outer surface for a first image to be printed and a first end, and
a shell having an inner surface circumferentially disposed about the first end and having a gap for holding a printing plate, the shell being axially moveable with respect to the first end and having a shell outer surface for a second image to be printed, the inner surface having at least one projection directed inwardly, the gap extending into the projection.

2. The cylinder as recited in claim 1 wherein the shell is circumferentially movable with respect to the cylinder body.

3. The cylinder as recited in claim 1 wherein the at least one projection includes a plurality of projections.

4. The cylinder as recited in claim 1 wherein the shell has an additional gap spaced circumferentially with respect to the gap.

5. The cylinder as recited in claim 4 wherein the wherein the at least one projection includes a first projection and a second projection, the gap being located in the first projection and the additional gap in the second projection.

6. The cylinder as recited in claim 3 wherein the plurality of projections are spaced symmetrically in the circumferential direction.

7. The cylinder as recited in claim 1 wherein the cylinder body has at least one outwardly projecting protrusion.

8. The cylinder as recited in claim 7 wherein the at least one protrusion includes a plurality of protrusions.

9. The cylinder as recited in claim 8 wherein the projection of the shell fits between two of the plurality of protrusions.

10. The cylinder as recited in claim 9 wherein the two protrusions define a space for the projection, the space being wider than the projection.

11. The cylinder as recited in claim 1 wherein the cylinder body has a second end and further comprising a second shell supported on the second end.

12. The cylinder as recited in claim 1 further comprising a lock-up device located in the gap.

13. A plate cylinder comprising:
a cylinder body having cylinder body outer surface for a first image to be printed and a first end with at least one outwardly-projecting protrusion having a first side and second side defining a space therebetween, and
a shell having an inner surface circumferentially disposed about the first end and having a gap for holding a printing plate, the shell being axially moveable with respect to the first end and having a shell outer surface for a second image to be printed, the inner surface having at least one projection directed inwardly to fit into the space, the space being wider than the projection so as to permit circumferential movement of the shell with respect to the first end.

14. The cylinder as recited in claim 13 wherein the at least one protrusion includes a first and a second protrusion, with the first side on the first protrusion and the second side on the second protrusion.

15. An offset lithographic printing press comprising:
a plate cylinder having a cylinder body having a cylinder body outer surface for a first image to be printed and a first end, and a shell having an inner surface circumferentially disposed about the first end and having a gap for holding a printing plate, the shell being axially moveable with respect to the first end and having a shell outer surface for a second image to be printed, the inner surface having at least one projection directed inwardly, the gap extending into the projection; and
a blanket cylinder contacting the plate cylinder.
